(19) United States
(12) Patent Application Publication
(10) Pub. No.: US 2009/0069937 A1
(43) Pub. Date: Mar. 12, 2009

(54) Method and Device for The Fully Authomatic Final Inspection of Components and/or Their Functional Units

(76) Inventor: Gunter Battenberg, Marburg (DE)

Correspondence Address: CLARK & BRODY, 1090 VERMONT AVENUE, NW, SUITE 250, WASHINGTON, DC, 20005, US

(21) Appl. No.: 12/223,714

(22) PCT Filed: Feb. 9, 2007
(86) PCT No.: PCT/EP2007/001129

§ 371 Date: Aug. 7, 2008

(30) Foreign Application Priority Data
Feb. 9, 2006 (DE) 10 2006 006 246.9

(51) Int. Cl. G05B 19/418

(52) U.S. Cl. 700/254; 901/4; 901/10; 901/47

(57) ABSTRACT

The object of the present invention is equipment (1) and a method for the fully automated final inspection of components (2), in particular of their driven modules, further comprising a robot (3) fitted with a testing system (8) to carry out the final inspection comprising the stages: Self-driven alignment of the robot (3) and/or the testing system (8) relative to the component (2) being checked and/or its module by means of orientation data, reproducible implementation of individual checks by the testing system (8), the stages of self-driven alignment and reproducible implementation being repeated until a termination criterion has been met and/or the final inspection has been completed.

The present invention relates to a method and equipment for the final, fully automated inspection of components.

Complex products most of the time are manufactured in production procedures and in production stages by the production of sub-assemblies, in particular components, modules, hereafter modules, and the like that are made in partly independent stages, the sub-assemblies, components etc. being modular and assembled into the final product. As a rule the components are inserted into a spatial structure receiving the modular components, for instance a housing, a framework and the like.

Because of tolerances or deviations from reference values regarding manufacture, assembly and the like, the components may be configured deviating from a nominal position in said spatial structure. Where complex and expansive products comprising a plurality of sub-assemblies and/or components to be configured in a spatial structure are involved, the tolerances might accrue in the manner of error propagation or even exponentially with commensurate problems when finally assembling the components into the spatial structure, whereby for instance the components no longer fit into said structure for lack of space from accumulating tolerance defects.

Frequently the components per se comprise further elements or modules, as a result of which they too may be manufactured defectively due to irregularities. Illustratively the component might still be properly fifted into the spatial structure but the operation of said component might be unsatisfactory.

In addition a plurality of defective configurations, designs and the like might arise that should be precluded from the final product.

In order to assure the best possible final products consisting of a sub-assembly or a component configured within a spatial structure, it is known to have a skilled operator manually check and remove the final product. In particular the driven modules test is carried out manually, customers insisting on personal perception and corresponding agreeable customer perception can be assured only by manual testing, not by machine inspection.

Especially as regards very complex final products with a plurality of assemblies, for instance a motor vehicle, an exceedingly large number of checks must be carried out that are extremely costly in time and labor. Moreover manual checking is poorly reproducible and depends much on the personalities of the testers.

The objective of the present invention is to create a method and equipment for the fully automated final inspection of components and/or modules which are configured in particular within a spatial structure. The present invention also proposes sensors to be used in a method and/or equipment for fully automated final inspection.

This problem is solved by a method defined in claim 1 and equipment defined in claim 36. Also, this problem is solved by a computer program and a computer program product defined in claims 34 and 35 respectively. Another factor in the solution is a sensor defined in claim 46. Advanced embodiment modes and advantageous further designs are defined in the dependent claims.

The present invention includes a technical disclosure that, for fully automated final inspection of components, in particular driven modules, by means of a robot fitted with a testing system carrying out said final inspection, the method of the present invention comprises the following stages: Independent alignment of the robot and/or the testing system relative to the component to be tested and/or its module using orientation data, Reproducible individual checks by means of the testing system, the stages of independent alignment and reproducible implementation being repeated until a termination criterion has been met and/or the final inspection has been completed.

This fully automated final inspection can be carried out reproducibly and at constant quality by obeying specified and always the same defaults.

A component is any part that for instance may be inserted into a spatial structure. Preferably the components are mass-produced. In particular the components may be test-ed already before being configured in the spatial structure(s), for instance on a product belt or the like. In this manner a final component inspection can be fully automated when the components are configured in different positions and orientations, for instance on the production belt. Such components also may be all those found in a motor vehicle, for instance within a motor vehicle cockpit, for instance being a radio, switching levers, steering wheel, GPS, air conditioning and heater and the like. The components may be designed for different purposes such as being switches, operating elements, controls, displays and the like.

Preferably a robot arm shall be used to carry out a fully automated final inspection and advantageously shall include a testing system.

In a first stage, the robot initiates automated alignment. As a result, the robot, its arm and in particular the testing system are aligned. To carry out such alignment, the rotor moreover is fitted with a sensor unit detecting orientation data. By means of this sensor unit, the robot detects information both about its own position and about that of the testing system. The sensor unit may be a gyroscope or force/torque detector. The orientation data include in particular positional data or rotation information which can be represented by at least one of the vectors and/or directions along and/or about an x-axis, about a y-axis and/or about a z-axis. A Cartesian coordinate system may be used for data detection, allowing detecting and/or processing the orientation data. However any other coordinate system is applicable illustratively using cylindrical or polar coordinates as well as transformed coordinate systems may be used.

The processing of orientation data assumes a fixed system of coordinates which illustratively is selected in relation to a spatial structure. The components and their spatial configurations as well as their spatial rotations may then be detected in terms of said fixed system of coordinates, be stored and/or worked out.

Accordingly orientation data contain all information about configuration of a component, a spatial structure, a module and the like in a preferably 3D space.

The testing system carries out reproducible individual checks.

In order to subject the full final product to a final inspection, the individual checks and where required also the alignments are carried out as long and repeatedly until the final inspection has been completed, its modules have been included or an arbitrary termination criterion has been met.

Preferably the stage of detecting, storing and/or retrieving orientation data by the robot, the testing system, the component and/or its modules, shall be included.

The orientation data containing information about the particular configuration and/or rotation in 3D space may be independently detected by the robot by means of its sensor unit. Said information then may be stored in a manner to be subsequently retrieved or be further processed for optimization.

However orientation data also may be predetermined. Presently much data regarding components, spatial structures and the like are available in model form, for instance as CAD data and the like. They also allow inferring orientation data for the robot respectively its control. Illustratively previously stored CAD data of orientation may be stored as nominal defaults and allow a first position determination by the robot.

Preferably the predetermined and retrieved orientation data may be compared with the detected orientation data and be optimized using calculation algorithms to optimize operational procedures, in particular testing.

Preferably the data shall be continuously optimized and/or the stage of automated alignment shall further contain the following step: Displacing at least one arm of the robot and/or of the testing system regarding detected and/or retrieved orientation data. Especially as regards optimized orientation data, the robot arm may be positioned rapidly and reliably, assuring thereby a rapid check or final inspection. In particular such a feature allows final inspection by machine.

Preferably also the stage of detection and/or storage of orientation data of the robot, of the testing system, of the component and/or of its modules shall include the following step: Detecting and/or storing orientation data relating to the robot, the testing system, the component and/or its modules in relation to predetermined orientation data.

If a fixed system of coordinates is selected to drive the robot, then all spatial structures, components etc. may be detected relative to this system of coordinates, stored and/or retrieved. This feature offers the advantage that in the event of mismatch or a shift of the fixed system of coordinates, the orientations already acquired may be used further.

In a preferred embodiment mode of the present invention, the stage of automated alignment further includes the following step: calculating the data regarding the position the testing system should be moved into by to implement reproducibly the final inspection. Because the position to move into is calculated before each individual check is undertaken, each individual check can always be optimal and adaptive even under changed conditions such as lacking or additional properties of the component to be checked and the like. Accordingly there is always recalculation of data taking into account different and changing installation situations.

Preferably again the stage of calculating the data relating to the position to be moved into by the testing system further includes the following step: Calculating the data regarding the position the testing system must move into using a position recognition algorithm. Known and reliable algorithms may be used for that purpose, said algorithms illustratively also being in the form of software, as a result of which methods are easily adapted and sufficiently available and in this manner are also compatible with extant controls. Illustratively a position recognition algorithm may be a triangulation principle algorithm. In another advantageous implementation of the present invention, the information calculation stage regarding the position the testing system must move into includes also the following step: Calculating the information regarding the position into which the testing system must move using a position recognition algorithm based on the triangulation principle.

Preferably, moreover, the stage of reproducible implementation further contains the following step: Calculating, detecting, storing and/or retrieving the data concerning the component, or its module, to be tested, inclusive the test data for the testing coming up. Testing requires more than knowing the orientation data of component to be checked. In particular further data are required specifically for checking. Illustratively checking a switch must be carried out otherwise than for instance for a display. Also other forces and/or displacements may be required for different switches. In particular as regards multifunction switches which by being rotated and/or depressed allow retrieving said functions, every one of latter must be checked out. This information must be transmitted to the robot.

Accordingly it is advantageous that the stage of reproducible implementation further contain the procedure of a single check based on the test data. Individual checking may therefore take place for every unit to be tested, with maximum quality control being assured.

To assure qualitative high-grade final inspection, moreover, it is advantageous that the stage of reproducible implementation also shall contain the following step: Detecting at least one datum regarding the implementation feedback of the individual check. The feedback so obtained allows rating the check. The rating may be in binary or digital form, for instance such as “module operative”, “module inoperative”, and/or also it may be quantitative. The quantitative rating allows sorting components into specified “classes of quality”. Components belonging to a qualitative high-grade quality class may be correspondingly integrated into a high-grade final product or being introduced into a high-grade final product, and a qualitatively lesser high-grade component may be used in a correspondingly lower quality final product. Components may be used more economically in this manner.

All the data may be predetermined by programming or be detected by automation. However programming for automated detection is often highly costly and/or time consuming.

Therefore it is often advantageous that the information regarding displacement inclusive the orientation information of the component to be checked and/or its driven module and/or the testing information be secured by a teaching procedure. In latter the robot and/or the testing system is manually moved along or with the desired orientation data. In this simple manner required information may be acquired short of special programming know-how. The robot processes accordingly the information secured through the teaching procedure and then converts it.

The robot may be displaced in more ways than just manually. The checking also may be carried out manually and the robot may receive the test data accordingly.

The teaching procedure may be carried out by manually operating the robot. In a special design of the present invention, the teaching procedure includes the following steps: Manually guiding and/or handling the robot and/or the testing system by displacing/handling a measuring sensor of the testing system, detecting information by means of manual guidance and retrievable storage of the data collected by said manual guidance. Highly accurate acquisition of information is made possible in particular by handling the measuring sensor respectively the front tip of the rotor or more accurately the testing system. Moreover such handling is very accurate and the test and/or the check can be carried out under real conditions. As a result there is no need for several teaching passes as would be necessary in the presence of inaccurate or defective handling.

Even though the teaching procedure provides highly reliable information by manual operation of the front tip respectively the measurement sensor, said information can still be substantially improved by a machine operated final inspection. Advantageously the teaching procedure includes the further step: Optimizing the detected information. Such optimization illustratively may be applied to the length of the displacement path, the time, the rotations and/or the number of changes in direction and/or operational steps.

As discussed above, advantageously the teaching procedure includes the further steps: Manually carrying out the individual checks, retrievably storing the detected data by means of individual checks. In this manner the final inspection may be optimized at little programming cost.

Advantageously the method for the fully automated final inspection can be carried out at a timed production line. In this case the final inspection already can take place during production directly after integrating a component. A typical application of the method may be an automobile assembly line where the finished motor vehicles undergo a fully automated final inspection.

In particular the component to be tested and/or its module and the robot may be configured in different, bounded spatial structures connected by one access site before the method is carried out. In this instance the robot respectively its testing system must be moved into the other spatial structure. An example of the different spatial structures may be found in the above cited motor vehicle production line, in particular the inside and outside of a finished motor vehicle. The robot then is configured outside the motor vehicle and the components are inserted into this vehicle. To carry out the final inspection, the robot, respectively the testing system which may be mounted in particular at the outer arm of a robot arm, must then be moved into the motor vehicle, that is into the other spatial structure.

As cited above, a preferred embodiment mode provides that a spatial structure containing the component to be tested and/or its module is a motor vehicle. The displacement into the other spatial structure of the motor vehicle takes place by means of an access site which may assume a different geometry and in particular may be of a different size.

Accordingly the method of the present invention preferably includes the following stages: Finding an access site and moving the robot and/or the testing system through the access site where the steps of finding and displacing are carried out before the step of automated alignment is. As a result, when for instance the access site is closed following final assembly, the displacement can be implemented nevertheless reliably and free of error by means of the search algorithm. In case a spatial structure is a motor vehicle, then a motor vehicle door, the trunk and the like may constitute the access site respectively the part closing off the access site. More specifically, the access site is constituted by the closed region subtended by the displaceable parts of the motor vehicle body adjacent to the inside or closed space containing the part to be tested. In order to carry out the final inspection in fully automated manner, the robot arm for instance must find/locate the door, the trunk, the hood and the like, then must open same and hence make the access site accessible. Following this step the robot is able to move into the other spatial structure and continue implementing the method.

Accordingly the present invention provides that said displacements include the further steps: Detecting the access site and opening it, the step of opening the access site preceding the step of moving the robot through the access site.

In a further advantageous embodiment mode of the present invention, the step of robot displacement can be carried out by moving on at least one linear displacement axle. As a result the robot implementing the final inspection may be arbitrarily linearly displaced, allowing easy control. Especially as regards the configuration of the robot and of the components in different spatial structures, the robot may be moved along an optimized path outside the spatial structure containing the component being tested, and especially, as regards several access sites, the optimal access site may be approached. Obviously any other displacement system to move the robot is also feasible, for instance along a circular path or using a 3D rail system.

In order that the final inspection be applicable as widely as possible, the displacement stage preferably shall include—besides the component detection, storage and retrieval stage—also said component's multi-dimensional detection, storage and/or retrieval, including components with arbitrary, including free-form surfaces. In this manner even complex and typically monitoring-resistant free-form surfaces may be checked in fully automated manner.

In another advantageous embodiment mode of the present invention, the component detection is by three-point measurement which also can be carried out in more than one plane in the manner of a triangulation procedure.

In particular when detecting, storing and/or retrieving data, these data are processed while selected from the group of optical, acoustic, electric, electronic and/or haptic data. The customer's relevant and sales-significant criteria are processed in that manner.

Preferably when detecting optical data, these will be selected from the group of data relating to illumination, symbols, pixels, geometries, gap sizes, color, light reflection, leveling, gloss, granulation and the like.

Preferably again, when detecting haptic data, these will be selected from the group containing information about elasticity, rigidity, reset rates, friction, roughness, topography, sensed temperatures, hardness, force profile, torque, stereotype operation and the like.

Preferably, when detecting acoustic information, that information will be selected from the set containing click noises, impacts, operational noises, sounds and the like.

In an advantageous embodiment mode of the present invention, optical detection is carried out at a resolution in the range between 0 and 10 microns (μ), preferably in a range larger than or equal to 0 but smaller or equal to 5 p, and most preferred from 0 to smaller than or equal to 1μ. This high resolution assures high quality standards.

Similar considerations apply to the preferred embodiment mode wherein the resolution of haptic detection is in a range equal to or larger than 0 to equal to or smaller than 10° C., preferably in the range from equal to or larger than 0 to 5° C. and especially in the range from equal to or larger than 0 to equal to or less than 1° C., and/or the force dependent detection in a force magnitude range is carried out at a resolution in a range equal to or larger than 0 N or 0 Nm to smaller than or equal to 5 N or 5 Nm and most preferred in a range equal to or larger than 0 N or 0 Nm to smaller than or equal to 1 N or Nm.

Advantageously again the resolution of acoustic detection takes place within a frequency range equal to or larger than 0 Hz to smaller than or equal to 150 kHz, preferably in a range from equal to or larger than 0 Hz to smaller than or equal to 100 kHz, and most preferred in a range from equal to or larger than 0 Hz to less than or equal to 50 kHz, especially 44.1 kHz.

To assure high quality standards, it is especially preferred that at least one of the stages be carried out repeatedly to increase its accuracy until a termination criterion has been met. Accuracy may be increased as need by iteration, either for the entire process or only for individual checks.

Because of the high timing rates and increasing time pressures, advantageously the stages of independent alignments and reproducible implementations of an individual check are carried out at a clock rate/timing equal to or larger than 0 seconds (s) to equal to or less than 3,600 s, preferably in a range equal to or larger than 0 s to equal to or less than 1,800 s and most preferred in a range equal to or larger than 0 s to equal to or less than 900 s.

To increase the comfort of personnel, for instance regarding their interventions, and to reduce wiring/cording and other transmission means, advantageously at least one of the stages shall be controlled acoustically by means of a speech recognition and/or input system. In this manner an operator may have both hands free and if called for may use them for other tasks by appropriately instructing the robot. In this manner method efficiency is increased. Especially in emergencies or malfunctions, the control also may be corrected over larger distances.

Advantageously again, the data are selected without resort to wiring in at least one stage using wireless methods selected from the group of WLAN, Bluetooth and the like. This feature reduces material cost and makes easier transmission also to several sites.

The present technical disclosure provides also computer programs with program coding means to implement all stages of each of the above methods when the program is run on a computer.

The same applies to a computer program product with program coding means stored on a computer-readable data medium to carry out an arbitrary predetermined program when the program product is implemented on a computer. As a result the method may be easily transferred to other systems and be carried out by them.

The technical disclosure of the present invention further provides equipment having means to carry out the method of said invention.

As a result the method also may be practically applied to various fields.

As already mentioned previously, the system includes a robot fitted with at least one position sensor and at least one testing system. The term “robot” herein denotes any manipulating means, in particular a fully automated one.

Preferably the testing system comprises at least one function testing unit and at least one sensor to detect the function testing unit feedback. In this manner the component functions can be tested automatically whereas previously they could only be tested manually.

Preferably at least one of the sensors is a microsensor. As a result the testing system may be miniaturized, for instance the weight of the microsensor only minimally affecting checking.

In a preferred embodiment mode of the present invention, the microsensor is fitted with means detecting magnitudes of force and torque, thermal values including temperature, and/or haptic values. As a result all relevant data may be submitted to the fully automated final inspection.

Advantageously, the means detecting the force magnitudes include at least one piezo-resistor to detect force and/or torque. This piezo-resistor is compact and offers reliable results, allowing reduction in bulk.

Preferably at least one means detecting thermal values includes at least one thermocouple

The present invention offers the further advantage that the means detecting haptic values include a plurality of receptors operating in the manner of a haptic finger. In this manner the human haptic sensory perceptions are optimally reproduced and as a result optimized final inspection can be carried out.

In order to configure the largest possible number of receptors and hence also many microsensors into a small volume, preferably the plurality of receptors used to detect the haptic magnitude shall be configured on a microsensor having a base surface in a range equal to or less than 50 mm×50 mm, preferably equal to or less than 25 mm×25 mm, and in particular being 15 mm×15 mm. The microsensor with the plurality of receptors is fitted with a base body receiving said receptors on it or in it. Said base body's shape may be arbitrary, however preferably when viewed in topview it exhibits a rectangular, preferably square base surface. The smaller the receptors, the smaller also the base body respectively its base surface.

In one advantageous embodiment of the present invention, at least one sensor is designed as a multi-axis force-torque sensor to detect forces and torques in at least one, preferably several directions to detect orientation data. Illustratively the force/torque sensor can detect forces and/or torques respectively their vector components for instance in a 3D Cartesian coordinate system along and/or about their three axes. Again arbitrary systems of coordinates also are applicable.

Further features, details and advantages of the present invention are stated in the claims and also in the description below of illustrative embodiments shown in the drawings.

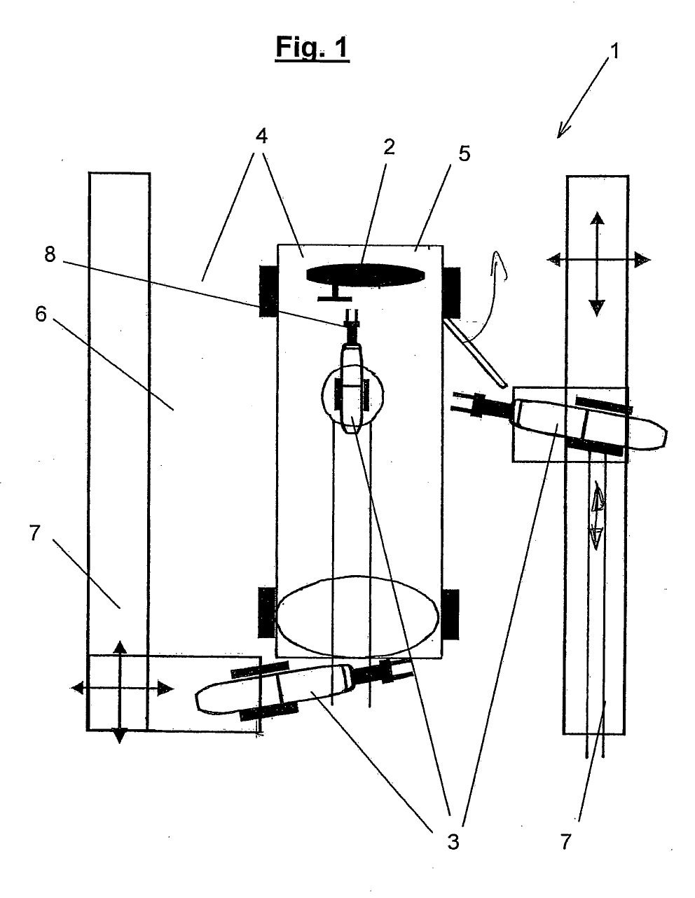

FIG. 1 is a schematic topview of the equipment of the invention implementing the invention's method,

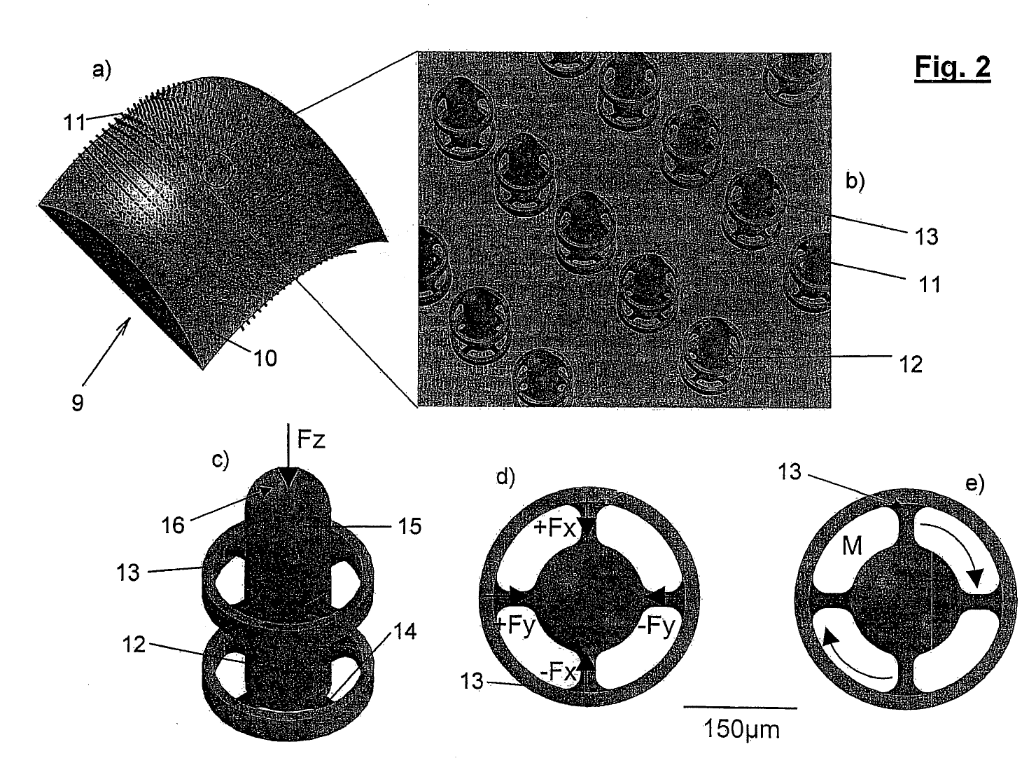

FIGS. 2a-2e schematically show design of a microsensor with receptors and

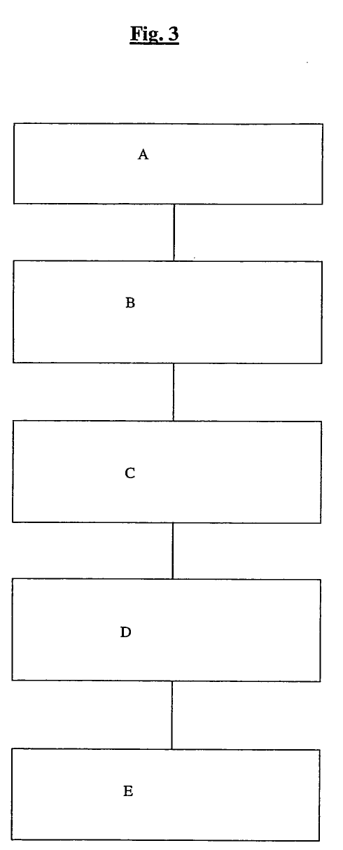

FIG. 3 is a flow chart of the method of the invention.

FIG. 1 is a schematic topview of equipment 1 carrying out the method of the invention fully automating the final inspection of components 2 and the like.

The equipment 1 shown in FIG. 1 comprises three robots 3. The robots 3 and the components to be checked are configured before final inspection in different spatial structures 4. In this embodiment a spatial structure 4 is a schematically shown motor vehicle 5. A component 2 in the form of an automotive cockpit is mounted in the motor vehicle. The robots 3 are configured outside the motor vehicle 5 in another test chamber 6 in the form of another spatial structure 4 before final inspection begins.

The robots 3 are mounted in displaceable manner and, in the state of the equipment shown in FIG. 1, two robots are outside the motor vehicle 5 and one robot 3 is shown already having been moved into the motor vehicle 5. To displace the robots 3, they are mounted on corresponding displacement means 7, more accurately stated, mechanical compound slides, for instance, as shown in this case, cross-benches. These cross-benches are preferably bi-axially and linearly displaceable. The robots are fitted with omitted measurement sensors to process orientation data by means of which a robot may orient itself within the spatial structures. The orientation in space and object detection is implemented by 2D or 3D sensors mounted terminally on each robot arm. The approach to the measurement reference points is in the range of +/−2.5 mm.

Each robot arm also bears a testing system 8 to run individual checks on a component 2 to be tested or on a vector component to be monitored. The testing system 8 processes data relating to the component 2 being checked—to detect it more accurately—and to carry out an individual check for instance on a module and to record the results of the individual component check or its feedback during the individual check.

Special measurement sensors are required for feedback detection, for instance haptically detected feedback. FIGS. 2(a-e) illustrate a measurement sensor also used for haptic detection.

FIG. 2a schematically shows a measurement sensor 9. This microsensor is 3D and is able to haptically detect surfaces and/or force information relating to 3D components. The microsensor comprises a base body 10, a plurality of receptors 11 being designed and/or mounted on said base body. This plurality of receptors 11 allows haptically detecting a 3D surface, said receptors acting in this respect like “haptic fingers”.

FIG. 2b schematically shows a cutaway of the microsensor of FIG. 2a. The configuration and shape of the receptors 11 is shown. The receptors 11 preferably are arrayed in fields, especially also in several rows next to each other. The shape of the receptors 11 is approximately like an axle or a shaft 12 fitted at both ends with wheel-like elements 13, the axle or shaft 12 projecting more at one wheel-like element 13 than that configured at the other side. The shape of a receptor 11 is shown in more detail in FIG. 2c.

FIG. 2c shows schematically and on a larger scale a perspective of a microsensor receptor 11. The wheel-like elements 13 comprise four spoke-like links 14 connected to the shaft 12. One wheel-like element 13 terminates approximately flush with one end of the shaft 12 (or axle). The second element 13 is essentially the same as the first one and also is fitted with spoke-like links 14 connected to the shaft 12. However the second wheel-like element 13 is configured not at the other end of the shaft 12, but more centrally, as a result of which part of the shaft 12 projects beyond it and constitutes a protrusion zone 15. This protrusion zone 15 is rounded at its outer end and is preferably designed as a thermocouple 16 to detect thermal information.

The shaft 12 or axle of the receptor 11 preferably subtends the z-axis. The four spoke-like links 14 preferably are mutually orthogonal to each other and subtend pair-wise an x-axis and a y-axis whereby the receptor 11 may detect data and may process such data in the preferred system of coordinates, namely as Cartesian vector components. The two wheel-like elements 13 are similar externally but carry out different functions.

FIG. 2d is a schematic topview of one of the two wheel-like elements 13. Said element 13 is designed to be a piezo-resistor detecting forces. Mainly force components in the +x, −x, +y, −y directions are detected on the basis of the above described Cartesian coordinate system. In FIG. 2d, these forces are respectively denoted by +Fx, −Fx, +Fy, −Fy and by the associated arrows indicating the respective vectors.

FIG. 2e is a schematic topview of the other of the two wheel-like elements 13. This element too is a piezo-resistor, though designed to pick up torques especially those about the z-axis as schematically indicated by the letter M and the curving arrows.

A line underneath FIGS. 2d, 2e shows a line measurement unit actually representing a real length of about 150μ. This scale applies only to FIGS. 2e and 2d.

The microsensor shown in FIGS. 2a through 2e is particularly applicable to actuation haptics, touch haptics, reproducing finger pads, haptic perception of surfaces, intelligent switch surfaces, intelligent surfaces, the full surface reacting to contact with a person and/or the surfaces deforming depending on touching, as a result of which the microsensors also are appropriate for pedestrian safety and in airbag fitting.

Due to its design and the plurality of receptors 11, the microsensor is suitable to measure forces in three dimensions, torques in three dimensions and the contact temperature to touch.

FIG. 3 is a flow chart of a method in five stages used for a fully automated final inspection. The stages are denoted by the five letters A through E.

After the object being monitored, for instance a finally assembled motor vehicle, has been moved into its test position and where called for the access site has been opened, the robot, which is mounted on a linear axle, moves automatically in stage A into the motor vehicle.

The data regarding the test or monitoring sequence—that like the nominal test positions were already programmed offline respectively determined from CAD data—are retrieved in stage B.

In stage C the robot orients itself in the grid of vehicle coordinates and in this process locates respectively aligns itself automatically.

The actual position is computed in stage D from the programmed test sequence, the CAD data and the vehicle coordinates, and then testing/checking begins. The corresponding data are then processed in a robotic measurement unit.

The corresponding component functions or the component's modules are then tested or monitored in stage E. The individual motor vehicle components communicate in the total motor vehicle management by means of a motor vehicle bus system such as CAN, MOST, LIN or Flexray buses and transmit its function signals depending on robot actuation to the overriding control instruments. After the robot has initiated the function test by actuating a key or a control, the function is checked by means of the function tester connected to the vehicle.

In other words, component measurement points are generated in stage A. The vehicle coordinates are processed in stage B. Hence the robot is positioned in defined manner relative to the motor vehicle. The offset or a shift illustratively of the cockpit or of a switch is ascertained in stage C, and also reference points in the sampled procedure or by force sensors. Stage D measures the position and/or determines the contour of the individual component being checked using light section sensors or triangulation. Stage E covers the actual functional test of the pertinent component or its element.

The entire inspection procedure may be generated offline, for instance in a central office and then be transmitted by e-mail or data transfer to each arbitrary station.

The present invention is not restricted to one of the above modes of implementation but instead may be modified in versatile manner. It must be understood however that the object of the present invention are the equipment 1 and a method fully automating the final inspection of components 2, in particular their driven modules, using a robot 3 which comprises a testing system 8 with which to implement the final inspection, including the stages of automatically aligning the robot 3 and/or the testing system 8 relative to the component 2 being checked and/or its module by means of orientation data, reproducible individual checks by the testing system 8, the stages of automated alignment and reproducible individual checks being repeated until a termination criterion has been met and/or the final inspection has been completed.

All features and advantages of the specification and the drawings, including design details, spatial configurations and procedural steps may be construed being inventive per se or in their most diverse combinations.

### LIST OF REFERENCES

1 equipment
2 component
3 robot
4 spatial structure
5 motor vehicle
6 testing space
7 displacement elements
8 testing system
9 measurement sensor
10 base body
11 receptor
12 shaft
13 wheel-like element
14 spoke-like links
15 protrusion zone
16 thermocouple

1. A method implementing fully automated final inspection of components (2), in particular their driven functional units, hereafter driven modules, using a robot (3) fitted with a testing system (8) to carry out the final inspection, comprising the stages:
Automated alignment of the robot (3) and/or of the testing system (8) relative to the component (2) being checked and/or its functional unit/hereafter module, by means of orientation data,
Reproducibly carrying out individual checks using the testing system (8), the stages of automated alignment and reproducible checks being repeated until a termination criterion has been met and/or the final inspection has been completed.

2. Method as claimed in claim 1, further including the stage: Detection, storing and/or retrieving orientation data from the robot (3), from the testing system (8), the component (2) and/or from its modules.

3. Method as claimed in claim 1, where the stage of automated alignment further includes the step of displacing at least one robot arm of the robot (3) and/or the testing system (8) in relation to detected and/or retrieved orientation data.

4. Method as claimed in claim 1, where the stage of detection and/or storing orientation data of the robot (3), the testing system (8), the component (2) and/or its modules includes the step: Detection and/or storing orientation data of the robot (3), the testing system (8), the component (2) and/or its modules in relation to predetermined orientation data.

5. Method as claimed in claim 1, where the stage of automated alignment further includes the step: calculating the information regarding the position to move the testing system (8) into for reproducible implementation of the final inspection.

6. Method as claimed in claim 5, where the stage of calculating the information regarding the position into which to move the testing system (8) also includes the step: Calculating the information regarding the position into which the testing system (8) shall move using a position-recognizing algorithm.

7. Method as claimed in claim 5, where the stage of calculating, by means of a position recognizing algorithm, the information relating to the position to be approached by the testing system (8), further includes the step: Calculating the information relating to the position being approached by the testing system (8) using a position recognizing algorithm based on the triangulation principle.

8. Method as claimed in claim 1, where the stage of reproducible implementation further includes the step: Calculating, gathering, storing and/or retrieving information relating to the component (2) to be tested or its module inclusive the testing data for the check to be carried out.

9. Method as claimed in claim 1, where the stage of reproducible implementation includes the step: Carrying out an individual check using the testing information.

10. Method as claimed in claim 1, where the stage of reproducible implementation includes the step: Detecting at least one datum regarding the feedback from individual check implementation.

11. Method as claimed in claim 1, where the information, inclusive the orientation data of the component (2) to be checked and/or its test information, is acquired in a teaching procedure.

12. Method as claimed in claim 11, where the teaching procedure comprises the steps:
Manually guiding the robot (3) and/or the testing system (8) by displacing a measurement sensor (9) of the testing system (8).
Detecting the information by manual guidance, and
Retrievably depositing the information acquired by the manual guidance.

13. Method as claimed in claim 11, where the teaching procedure also includes the step of optimizing the collected information.

14. Method as claimed in claim 11, where the teaching procedure contains the further steps:
Manually carrying out the individual checks using the testing system (8),
Gathering the information by carrying out the individual checks,
Retrievably storing the information gathered by carrying out the individual checks.

15. Method as claimed in claim 1, where the method is carried out at a production line of a timed production belt.

16. Method as claimed in claim 1: where the component (2) to be checked and/or its module and the robot (3) are configured in different, bounded spatial structures (4) connected by one access site before the method of the invention shall be carried out.

17. Method as claimed in claim 16, where a spatial structure (4) containing the component (2) to be checked and/or its module is a motor vehicle (5).

18. Method as claimed in claim 16, comprising the steps: Locating an access site and displacing the robot (3) and/or the testing system (8) through the access site, the steps of locating and displacing being carried out before the stage of self-implemented alignment.

19. Method as claimed in claim 16, further including the steps:
Detecting the access site, and
Opening the access site, the step of opening the access site preceding the step of displacing the robot (3) through the access site.

20. Method as claimed in claim 1, where the step of displacing the robot (3) is carried out by moving on at least one linear displacement axle.

21. Method as claimed in claim 1, where the step of detecting, storing and/or retrieving the component (2) covers detecting, storing and/or retrieving free-form surface components including the component (2).

22. Method as claimed in claim 1, where the component (2) is detected by means of a three-point measurement, the three-pint measurement including measurement in more than one plane in the manner of triangulation.

23. Method as claimed in claim 1, where data selected from the group of optic, acoustic, electric, electronic and/or haptic information are processed when detecting, storing and/or retrieving information.

24. Method as claimed in claim 1, where, when optical information is detected, the information is in the group relating to illumination, symbols, pixels, geometry, gap sizes, color, light reflection, alignment/flushness, gloss intensity, granulation determination and the like.

25. Method as claimed in claim 1, where, when detecting haptic information, such information is selected from the group relating to elasticity, rigidity, reset rates, friction, roughness, topography, sensed temperatures, hardness, force profiles, torque, stereotyping operation and the like.

26. Method as claimed in claim 1, where, when detecting acoustic information, information is selected from the group relating to click noises, impacts, operating noises, sounds and the like.

27. Method as claimed in claim 1, where optical detection takes place at a resolution in the range between equal to or larger than 0μ to equal to or less than 10μ, preferably in a range from equal to or larger than 0μ to equal to or less than 5μ and most preferred in a range from 0μ to equal to or less than 1μ.

28. Method as claimed in claim 1, where the haptic detection is carried out in a temperature range at a resolution in a range from equal to or larger than 0° C. to equal to or less than 10° C., preferably in a range from equal to or larger than 0° C. to equal to or less than 5° C., and most preferred in a range from larger than 0° C. to equal to or less than 1° C. and/or the detection of force in a range of forces is carried out at a resolution in a range of equal to or larger than 0 or 0 Nm to equal to or less than 10 N or 10 Nm, preferably in a range from equal to or larger than 0 N or 0 Nm to equal to or less than 5 N or 5 Nm and most preferred in a range equal to or larger than 0 N or 0 Nm to equal to or less than 1 N or 1 Nm.

29. Method as claimed in claim 1, where the acoustic detection is carried out in a frequency range at a resolution within a range equal to or larger than 0 Hz to equal to or smaller than 150 kHz, preferably in a range equal to or larger than 0 Hz to equal to or smaller than 100 kHz and most preferred in a range equal to or larger than 0 Hz to equal to or smaller than 50 kHz, and especially at 44.1 kHz.

30. Method as claimed in claim 1, where at least one of the stages is carried out repeatedly to raise the stage accuracy until a termination criterion has been reached.

31. Method as claimed in claim 1, where the stages of self-driven alignment and reproducible implementation of a single check at a clock speed in a range from equal to or larger than 0 seconds (s) to equal to or less than 3,600 seconds, preferably in a range equal to or larger than 0 s to equal to or less than 1,800 s and most preferred in a range from equal to or larger than 0 s to equal to or less than 900 s.

32. Method as claimed in claim 1, where at least one of the stages is controlled acoustically by a speech recognition and/or speech input system.

33. Method as claimed in claim 1, where at least in one stage the information is selected in cordless manner using a wireless procedure selected from the group of WLAN, Bluetooth and the like manner.

34. A computer program with program coding means to carry out all stages and steps defined in claim 1 when operating the program on a computer.

35. A computer program product with program coding means stored on a computer-friendly data medium to carry out the method defined in claim 1 when the program product is run on a computer.

36. Equipment (1) fitted with means to carry out claim 1.

37. Equipment (1) as claimed in claim 36, comprising a robot (3) fitted with at least one position sensor and at least one testing system (8).

38. Equipment (1) as claimed in claim 36, where the testing system (8) comprises at least one functional test unit and at least one sensor gathering the module test feedback.

39. Equipment (1) as claimed in claim 36, whereby at least one of the sensor is a microsensor.

40. Equipment (1) as claimed in claim 36, where the microsensor is fitted with means detecting force magnitudes including forces and torques, thermal values including temperature, optical values and/or haptic magnitudes.

41. Equipment (1) as claimed in claim 36, where the means detecting force magnitudes include at least one piezo-resistor detecting forces and/or torques.

42. Equipment (1) as claimed in claim 36, where the means detecting a thermal value include at least one thermocouple.

43. Equipment as claimed in claim 36, where the means detecting a haptic magnitude include a plurality of receptors (11) acting as a kind of haptic finger.

44. Equipment as claimed in claim 36, where the plurality of receptors detecting the haptic magnitude are configured on a microsensor having a base surface of a size in a range equal to or less than 50 mm×50 mm, preferably in a range equal to or less than 25 mm×25 mm, and especially being 15 mm×15 mm.

45. Equipment as claimed in claim 36, comprising at least one sensor in the form of a multi-axis force-torque sensor detecting forces and three torques in three different directions to gather orientation data.

46. A sensor used in equipment claimed in claim 36, comprising a plurality of receptors (11) operating as a kind of haptic finger.

47. Sensor as claimed in claim 46, where the plurality of receptors detecting the haptic magnitude on a microsensor having a base surface of a size in a range equal to or less than 50 mm×50 mm, preferably a range of equal to or less than 25 mm×25 mm and in particular 15 mm×15 mm.

48. Sensor as claimed in claim 46, where the sensor is a multi-axis force/torque sensor detecting forces and three torques in three different directions to pick up orientation data.

49. A sensor used in a method of claim 1, comprising a plurality of receptors (11) operating as a kind of haptic finger.

50. Sensor as claimed in claim 49, where the plurality of receptors detecting the haptic magnitude on a microsensor having a base surface of a size in a range equal to or less than 50 mm×50 mm, preferably a range of equal to or less than 25 mm×25 mm and in particular 15 mm×15 mm.

51. Sensor as claimed in claim 49, where the sensor is a multi-axis force/torque sensor detecting forces and three torques in three different directions to pick up orientation data.
